(19) United States
(12) Patent Application Publication
(10) Pub. No.: US 2026/0326350 A1
(43) Pub. Date: Oct. 22, 2026

(54) INJECTION MOLDING SYSTEM AND INJECTION MOLDING DEVICE

(71) Applicant: SEIKO EPSON CORPORATION, Tokyo (JP)

(72) Inventor: Hiroki OTA, MATSUMOTO-SHI (JP)

(73) Assignee: SEIKO EPSON CORPORATION, Tokyo (JP)

(21) Appl. No.: 19/651,778

(22) Filed: Apr. 19, 2026

(30) Foreign Application Priority Data
Apr. 21, 2025 (JP) 2025-069379

(51) Int. Cl. B29C 45/03

(52) U.S. Cl. CPC B29C 45/03

(57) ABSTRACT

An injection molding system including a base having an installation surface and an injection molding device that is installed on the installation surface and that is configured to perform injection molding of a molded article using a mold, wherein the injection molding device includes a material supply section that feeds a material of the molded article, an injection section that injects the fed material into the mold, and a mold opening and closing section to which the mold is attached and that opens and closes the mold, the injection section includes a cylinder and a plunger that moves in the cylinder, the material supply section and the mold opening and closing section are located above the installation surface, at least a portion of the injection section is located below the installation surface, and the injection section injects the material into the mold by the plunger moving upward in the cylinder.

The present application is based on, and claims priority from JP Application Serial Number 2025-069379, filed Apr. 21, 2025, the disclosure of which is hereby incorporated by reference herein in its entirety.

### BACKGROUND

### 1. Technical Field

The present disclosure relates to an injection molding system and an injection molding device.

### 2. Related Art

An injection molding system is known in which a molded article is molded by injecting a plasticized material toward a cavity of a mold and curing the material.

For example, JP-A-2024-143192 describes an injection molding system including an injection molding machine that molds a molded article from a resin material supplied from a material supply device. The injection molding machine is disposed in an accommodation space and is fixed to an upper plate section of the housing. The injection molding machine is a horizontal injection molding machine located on the positive side in the X axis direction of the material supply device.

In the injection molding system as described above, miniaturization is desirable.

### SUMMARY

An aspect of an injection molding system according to the present disclosure includes
a base having an installation surface and
an injection molding device that is installed on the installation surface and that is configured to perform injection molding of a molded article using a mold, wherein
the injection molding device includes
a material supply section that feeds a material of the molded article,
an injection section that injects the material supplied from the material supply section into the mold, and
a mold opening and closing section to which the mold is attached and that opens and closes the mold,
the injection section includes a cylinder and a plunger that moves in the cylinder,
the material supply section and the mold opening and closing section are located above the installation surface,
at least a portion of the injection section is located below the installation surface, and
the injection section injects the material into the mold by the plunger moving upward in the cylinder.

An aspect of an injection molding device according to the present disclosure is
an injection molding device for performing injection molding of a molded article using a mold, wherein
the injection molding device includes
a material supply section that feeds a material of the molded article;
an injection section that injects the material supplied from the material supply section into the mold; and
a mold opening and closing section to which the mold is attached and that opens and closes the mold,
the injection section includes a cylinder and a plunger that moves in the cylinder,
the material supply section and the mold opening and closing section are located above an installation surface of a base on which the injection molding device is installed,
at least a portion of the injection section is located below the installation surface, and
the injection section injects the material into the mold by the plunger moving upward in the cylinder.

### BRIEF DESCRIPTION OF THE DRAWINGS

FIG. 1 is a side view schematically showing an injection molding system according to an embodiment.

FIG. 2 is a cross-sectional view schematically showing the injection molding system according to the present embodiment.

FIG. 3 is a perspective view schematically showing a flat screw of the injection molding system according to the present embodiment.

FIG. 4 is a diagram schematically showing a barrel of the injection molding system according to the present embodiment.

FIG. 5 is a cross-sectional view schematically showing the injection molding system according to the present embodiment.

FIG. 6 is a perspective view schematically showing a restriction section of the injection molding system according to the present embodiment.

### DESCRIPTION OF EMBODIMENTS

Hereinafter, a preferred embodiment of the present disclosure will be described in detail with reference to the drawings. Note that the embodiment described below does not unduly limit the scope of the present disclosure described in the claims. Not all of the configurations described below are necessarily essential constituent elements of the present disclosure.

### 1. Injection molding system

### 1.1. Overall Configuration

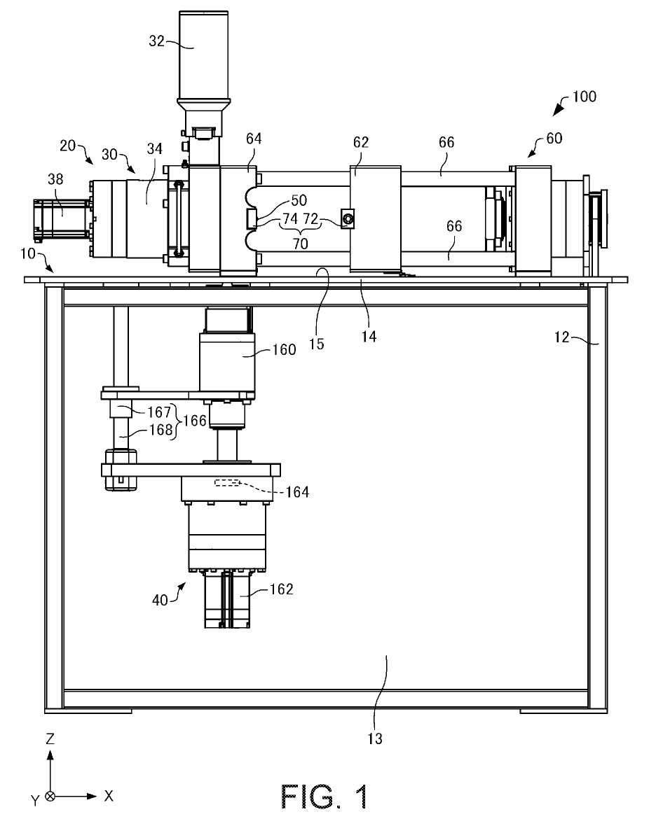

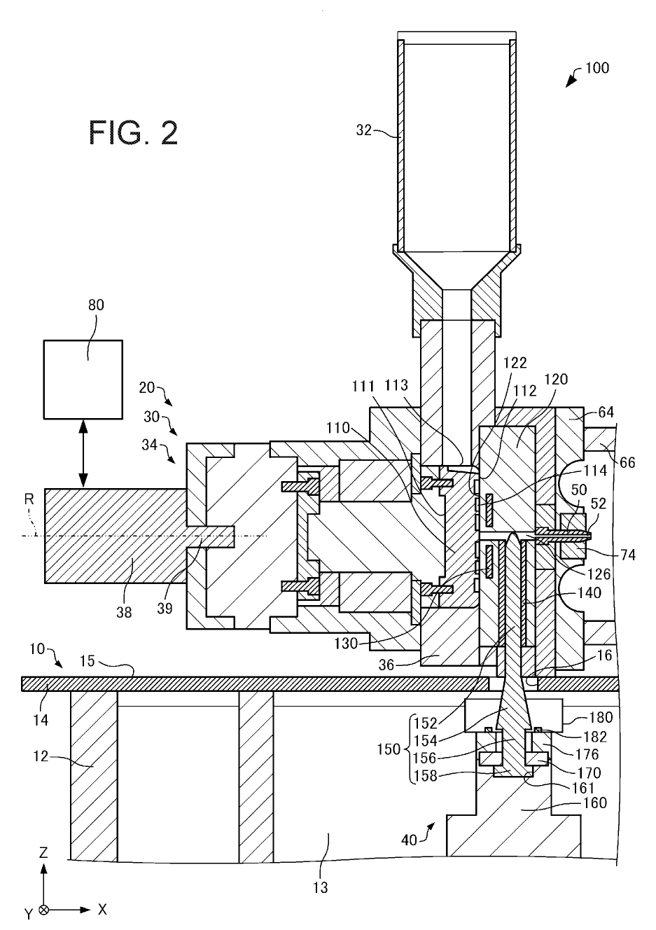

First, an injection molding system according to the present embodiment will be described with reference to the drawings. FIG. 1 is a side view schematically showing an injection molding system 100 according to the present embodiment. FIG. 2 is a cross-sectional view schematically showing the injection molding system 100 according to the present embodiment.

Note that in FIGS. 1 and 2, an X axis, a Y axis, and a Z axis are shown as three axes orthogonal to one another. The X axis direction and the Y axis direction are, for example, horizontal directions. The Z axis direction is, for example, a vertical direction. Specifically, the -Z axis direction is a gravity direction in which gravity acts. The +Z axis direction is a direction opposite to the direction of gravity.

As illustrated in FIGS. 1 and 2, the injection molding system 100 includes a base 10 and an injection molding device 20.

The base 10 supports the injection molding device 20. The base 10 includes, for example, a foundation 12 and a support plate 14.

The foundation 12 supports the support plate 14. The foundation 12 has an accommodation section 13 therein. The accommodation section 13 houses, for example, a power source (not illustrated) for supplying electricity to the injection molding device 20.

The support plate 14 is provided on the foundation 12. The support plate 14 has an installation surface 15 on which the injection molding device 20 is installed. The installation surface 15 is an upper surface of the support plate 14. In the illustrated example, a line perpendicular to the installation surface 15 is parallel to the Z axis, and the installation surface 15 faces the +Z axis direction. The installation surface 15 is, for example, a flat surface. As illustrated in FIG. 2, a hole section 16 is formed in the support plate 14.

The injection molding device 20 is provided on the base 10. The injection molding device 20 is installed on the installation surface 15 of the base 10. As illustrated in FIGS. 1 and 2, the injection molding device 20 includes, for example, a material supply section 30, an injection section 40, a nozzle 50, a mold opening and closing section 60 to which a mold 70 is attached, and a control section 80. The injection molding device 20 performs injection molding of a molded article using a mold 70.

The material supply section 30 supplies the material for the molded article. The material supplied from the material supply section 30 is, for example, acrylonitrile butadiene styrene (ABS) resin. The injection section 40 injects the material supplied from the material supply section 30 into the mold 70 via the nozzle 50. The mold 70 is attached to the mold opening and closing section 60. The mold opening and closing section 60 opens and closes the mold 70.

The material supply section 30 and the mold opening and closing section 60 are located above the installation surface 15. The material supply section 30 and the mold opening and closing section 60 may be positioned above the installation surface 15 in contact with the installation surface 15 or may be positioned above the installation surface 15 via a spacer (not illustrated). In the illustrated example, the material supply section 30 and the mold opening and closing section 60 are in contact with the installation surface 15.

The material supply section 30 and the mold opening and closing section 60 are arranged in the horizontal direction, for example. In the illustrated example, the material supply section 30 and the mold opening and closing section 60 are arranged in the X axis direction. The mold opening and closing section 60 is located on the +X axis direction side of the material supply section 30.

The control section 80 is configured by, for example, a computer including a processor, a main storage device, and an input and output interface that inputs and outputs signals from and to the outside. The control section 80 performs various functions by, for example, the processor executing a program read into the main storage device. Specifically, the control section 80 controls the material supply section 30, the injection section 40, and the mold opening and closing section 60. Note that the control section 80 may be configured by a combination of a plurality of circuits instead of a computer.

### 1.2. Specific Configuration

### 1.2.1. Material supply section

As illustrated in FIG. 2, the material supply section 30 includes, for example, a material supply mechanism 32 and a plasticization mechanism 34.

The material supply mechanism 32 supplies a material serving as a raw material to the plasticization mechanism 34. The material supply mechanism 32 is configured by, for example, a hopper. The material supplied from the material supply mechanism 32 has, for example, a pellet shape. The material supplied from the material supply mechanism 32 is, for example, acrylonitrile butadiene styrene (ABS) resin.

The plasticization mechanism 34 plasticizes at least a part of the material supplied from the material supply mechanism 32 to generate a pasty plasticized material having fluidity. The term “plasticization" is a concept including melting, and means changing from a solid to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The plasticization mechanism 34 includes, for example, a screw case 36, a drive motor 38, a screw 110, a barrel 120, and a heater 130.

The screw case 36 is a housing that accommodates the screw 110. For example, the screw 110 is accommodated in a space surrounded by the screw case 36 and the barrel 120.

The drive motor 38 is provided outside the screw case 36. The drive motor 38 is configured to include, for example, a servo motor. The shaft 39 of the drive motor 38 is connected to a shaft surface 111 of the screw 110 via, for example, a speed reducer. The drive motor 38 is controlled by the control section 80.

The screw 110 has a substantially cylindrical shape in which the size in the direction of the rotation axis R is smaller than the size in the direction orthogonal to the direction of the rotation axis R. The screw 110 is, for example, a flat screw. In the illustrated example, the rotation axis R is parallel to the X axis. The screw 110 rotates about the rotation axis R by the torque generated by the drive motor 38.

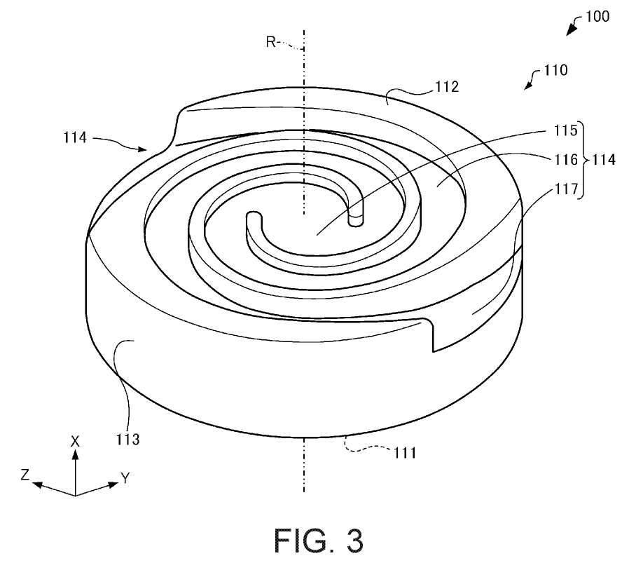

The screw 110 has a shaft surface 111, a groove forming surface 112 on the opposite side of the shaft surface 111, and a connection surface 113 connecting the shaft surface 111 and the groove forming surface 112. The groove forming surface 112 has a first groove 114. The connection surface 113 is perpendicular to the groove forming surface 112, for example. Here, FIG. 3 is a perspective view schematically showing the screw 110.

As illustrated in FIG. 3, the screw 110 has a groove forming surface 112 formed with a first groove 114. The first groove 114 includes, for example, a central section 115, a connection section 116, and a material introduction section 117. The central section 115 faces the communication hole 126 formed in the barrel 120. The central section 115 communicates with the communication hole 126. The connection section 116 connects the central section 115 and the material introduction section 117. In the illustrated example, the connection section 116 is provided in a spiral shape from the central section 115 toward the outer periphery of the groove forming surface 112. The material introduction section 117 is provided on the outer periphery of the groove forming surface 112. That is, the material introduction section 117 is formed on the connection surface 113 of the screw 110. The material supplied from the material supply mechanism 32 is introduced from the material introduction section 117 into the first groove 114, passes through the connection section 116 and the central section 115, and is transported to the communication hole 126 formed in the barrel 120. For example, two first grooves 114 are provided.

Note that the number of first grooves 114 is not particularly limited. Although not illustrated, three or more first grooves 114 may be formed, or only one first groove may be formed. Instead of being a flat screw, the screw 110 may be a long in-line screw having a spiral groove on a side surface thereof.

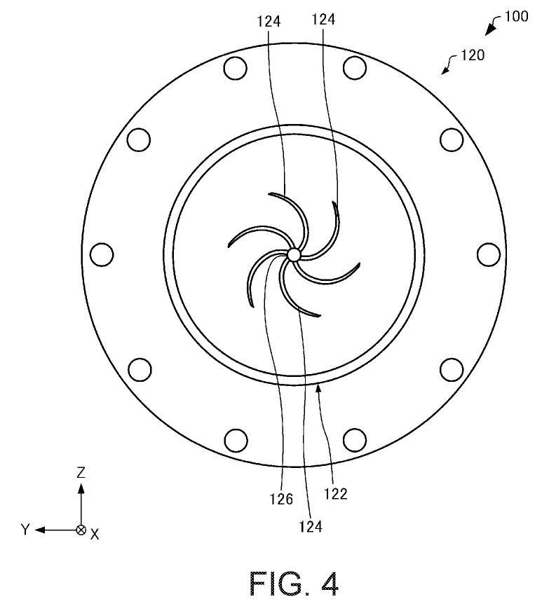

As illustrated in FIG. 2, the barrel 120 is provided, for example, on the +X axis direction side of the screw 110. The barrel 120 has a facing surface 122 that opposes the groove forming surface 112 of the screw 110. A communication hole 126 communicating with the first groove 114 is formed at the center of the facing surface 122. Here, FIG. 4 is a diagram schematically illustrating the barrel 120.

As illustrated in FIG. 4, a second groove 124 and a communication hole 126 are formed in the facing surface 122 of the barrel 120. A plurality of second grooves 124 are formed. In the illustrated example, six second grooves 124 are formed, but the number of second grooves 124 is not particularly limited. The plurality of second grooves 124 are formed around the communication hole 126 when viewed from the X axis direction. The second groove 124 has one end connected to the communication hole 126 and extends in a spiral shape from the communication hole 126 toward the outer periphery of the barrel 120. The second groove 124 has a function of guiding the plasticized material to the communication hole 126. In the illustrated example, the communication hole 126 extends in the X axis direction.

Note that although not illustrated, the shape of the second groove 124 is not particularly limited and may be, for example, a linear shape. The second groove 124 may not be connected to the communication hole 126 at one end. Further, the second groove 124 may not be formed in the facing surface 122. However, in consideration of efficiently guiding the plasticized material to the communication hole 126, the second groove 124 is preferably formed in the facing surface 122.

As illustrated in FIG. 2, the heater 130 is provided in the barrel 120. The heater 130 heats the material supplied between the screw 110 and the barrel 120. The output of the heater 130 is controlled by the control section 80. The plasticization mechanism 34 heats the material while conveying the material toward the communication hole 126 by the screw 110, the barrel 120, and the heater 130, and generates a plasticized material. Then, the plasticization mechanism 34 causes the generated plasticized material to flow out from the communication hole 126.

Note that although not illustrated, the shape of the heater 130 may be a ring shape when viewed from the X axis direction. The heater 130 may be provided on the +X axis direction side of the barrel 120.

### 1.2.2. Injection section

At least a portion of the injection section 40 is located below the installation surface 15. In the illustrated example, at least a portion of the injection section 40 is located on the -Z axis direction side of the installation surface 15. As illustrated in FIGS. 1 and 2, the injection section 40 includes, for example, a cylinder 140, a plunger 150, a support section 160, a plunger drive section 162, a pressure detection section 164, a plunger guide section 166, a restriction section 170, a fixing section 176, and a collection section 180.

As illustrated in FIG. 2, the cylinder 140 is provided in the barrel 120. The cylinder 140 communicates with a communication hole 126 formed in the barrel 120. In the illustrated example, the cylinder 140 extends from the communication hole 126 in the -Z axis direction.

The plunger 150 moves within the cylinder 140. The plunger 150 slides within the cylinder 140. The injection section 40 injects the plasticized material into the mold 70 by the plunger 150 moving upward. The expression "the plunger 150 moves upward" means that the position of the tip of the plunger 150 becomes higher, and the plunger 150 may move in a direction inclined with respect to the vertical direction. In the illustrated example, the tip of the plunger 150 is the end of the plunger 150 in the +Z axis direction. The plunger 150 moves in the Z axis direction in the cylinder 140.

By moving the plunger 150 in the cylinder 140, the injection section 40 performs a measurement operation and an injection operation. The measurement operation refers to an operation of moving the plunger 150 in a direction away from the communication hole 126 to suck the plasticized material located in the communication hole 126 into the cylinder 140 and measuring the plasticized material in the cylinder 140. The injection operation refers to an operation of injecting the plasticized material in the cylinder 140 into the mold 70 via the nozzle 50 by moving the plunger 150 in a direction approaching the communication hole 126.

The plunger 150 includes, for example, a rod-shaped section 152, a tapered section 154, a narrow section 156, and a lower end section 158.

The rod-shaped section 152 moves inside the cylinder 140. The rod-shaped section 152 constitutes a tip of the plunger 150. In the illustrated example, the tip of the plunger 150 is located in the communication hole 126. The rod-shaped section 152 extends in the Z axis direction. The rod-shaped section 152 is inserted through the hole section 16 formed in the support plate 14. The rod-shaped section 152 is separated from the support plate 14 defining the hole section 16.

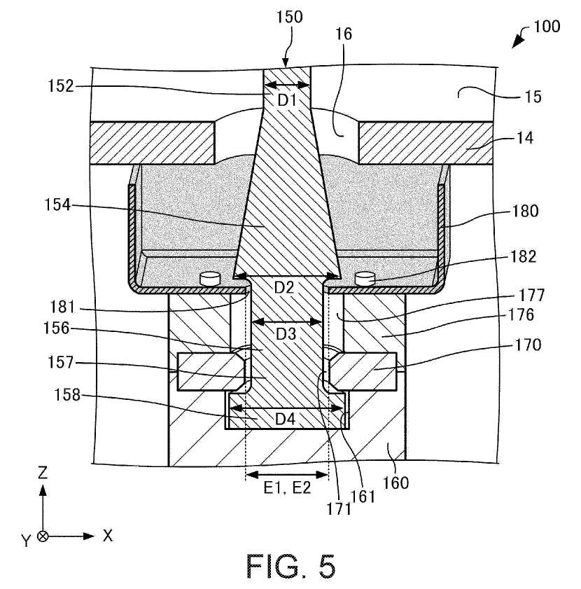

The tapered section 154 is located below the rod-shaped section 152. In the illustrated example, the tapered section 154 is located on the -Z axis direction side of the rod-shaped section 152. The tapered section 154 is located between the rod-shaped section 152 and the narrow section 156. The tapered section 154 has a tapered shape in which the width gradually increases from the rod-shaped section 152 toward the narrow section 156. Here, FIG. 5 is a cross-sectional view schematically showing the injection molding system 100, and is an enlarged view of the vicinity of the tapered section 154. As illustrated in FIG. 5, the diameter D2 of the tapered section 154 is larger than the diameter D1 of the rod-shaped section 152. The "diameter D2 of the tapered section 154" refers to the maximum diameter of the tapered section 154.

The narrow section 156 is located below the tapered section 154. The narrow section 156 is located between the tapered section 154 and the lower end section 158. The diameter D3 of the narrow section 156 is smaller than the diameter D2 of the tapered section 154.

The lower end section 158 is located below the narrow section 156. The lower end section 158 constitutes a lower end of the plunger 150. The diameter D4 of the lower end section 158 is greater than the diameter D3 of the narrow section 156.

The support section 160 is located below the plunger 150. The support section 160 supports the plunger 150. The support section 160 is in contact with the lower end section 158 of the plunger 150. The support section 160 has an opening section 161. The opening section 161 is formed in the upper surface of the support section 160. The lower end section 158 is positioned at the opening section 161.

As illustrated in FIG. 1, the plunger drive section 162 is located below the support section 160. The plunger drive section 162 drives the plunger 150. Specifically, the plunger drive section 162 moves the plunger 150 in the Z axis direction by moving the support section 160 in the Z axis direction. The plunger drive section 162 includes a motor, a gear, and the like. The plunger drive section 162 is controlled by the control section 80.

The pressure detection section 164 is located below the support section 160. In the illustrated example, the pressure detection section 164 is located between the support section 160 and the plunger drive section 162. The pressure detection section 164 detects the pressure applied to the plunger 150 by the plasticized material. In a case where the pressure detection section 164 detects a pressure equal to or higher than a predetermined value, the control section 80 controls the plunger drive section 162 to perform a process of causing the plunger 150 to suck the plasticized material. By this, the injection section 40 performs the above-described measurement operation.

The plunger guide section 166 guides the plunger 150. The plunger guide section 166 includes a linear bush 167 and a shaft 168. The shaft 168 extends in the Z axis direction. As the linear bush 167 slides on the shaft 168, the plunger guide section 166 guides the linear motion of the plunger 150.

The restriction section 170 is provided on the support section 160. The restriction section 170 is provided between the support section 160 and the fixing section 176. The restriction section 170 is in contact with, for example, the upper surface of the support section 160. The restriction section 170 may be in contact with the upper surface of the lower end section 158 of the plunger 150.

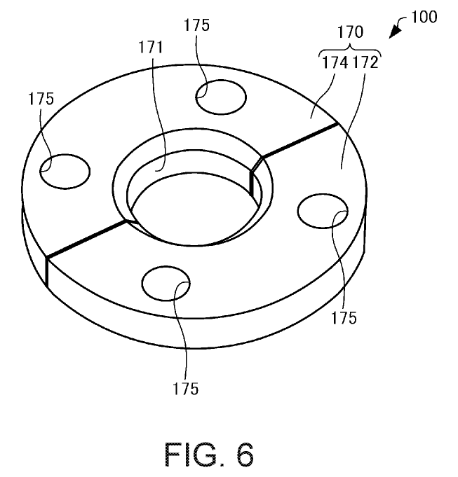

As illustrated in FIG. 5, the restriction section 170 has a hole section 171. The plunger 150 is inserted through the hole section 171. The narrow section 156 of the plunger 150 has an intra-hole section 157 located in the hole section 171. In the illustrated example, the narrow section 156 is separated from the restriction section 170, which defines the inner surface of the hole section 171. The lower end section 158 of the plunger 150 is located below the intra-hole section 157. The diameter D4 of the lower end section 158 is larger than the diameter E1 of the hole section 171. The restriction section 170 restricts the plunger 150 from moving away from the support section 160 and moving relative to the support section 160. Here, FIG. 6 is a perspective view schematically illustrating the restriction section 170.

As illustrated in FIG. 6, the shape of the restriction section 170 is, for example, a substantially disc shape. The shape of the hole section 171 is, for example, a circle when viewed from the Z axis direction. The restriction section 170 includes, for example, a first member 172 and a second member 174. The restriction section 170 is constituted by, for example, the first member 172 and the second member 174. In the illustrated example, the first member 172 and the second member 174 are in contact with each other. The first member 172 and the second member 174 are separable from each other. The first member 172 and the second member 174 have, for example, shapes symmetrical to each other. The restriction section 170 has a plurality of through holes 175. In the illustrated example, four through holes 175 are formed.

As illustrated in FIG. 5, the fixing section 176 is provided over the restriction section 170. The fixing section 176 is provided between the restriction section 170 and the collection section 180. A hole section 177 is formed in the fixing section 176. The plunger 150 is inserted through the hole section 177. The fixing section 176 is separated from the fixing section 176, which defines the inner surface of the hole section 177. The fixing section 176 has, for example, a screw (not illustrated). The screw passes through the through hole 175, which is formed in the restriction section 170, and is fastened to a screw hole formed in the upper surface of the support section 160. By this, the fixing section 176 fixes the restriction section 170 to the support section 160.

The collection section 180 is provided on the fixing section 176. The collection section 180 is located below the cylinder 140. The collection section 180 is provided between the fixing section 176 and the support plate 14. The collection section 180 is screwed to the fixing section 176 by screws 182. The collection section 180 has a substantially box shape having an opening on the upper side.

A hole section 181 is formed in the collection section 180. The shape of the hole section 181 is, for example, a circular shape when viewed from the Z axis direction. The plunger 150 is inserted through the hole section 181. The tapered section 154 of the plunger 150 is located above the hole section 181. The diameter D2 of the tapered section 154 is larger than the diameter E2 of the hole section 181. In the illustrated example, the diameter E1 of the hole section 171 and the diameter E2 of the hole section 181 are the same. When viewed from the Z axis direction, the outer periphery of the tapered section 154 is located outside the outer periphery of the hole section 181. The narrow section 156 of the plunger 150 is located in the hole section 181. The diameter D3 of the narrow section 156 is smaller than the diameter E2 of the hole section 181. The collection section 180 functions as a receiving tray that collects the plasticized material discharged from the cylinder 140 when the plasticized material is discharged from the cylinder 140.

The collection section 180, the fixing section 176, the restriction section 170, the plunger guide section 166, the pressure detection section 164, the plunger drive section 162, and the support section 160 are accommodated in the accommodation section 13 of the foundation 12. The collection section 180, the fixing section 176, the restriction section 170, the plunger guide section 166, the pressure detection section 164, the plunger drive section 162, and the support section 160 are located below the installation surface 15. Further, the tapered section 154, the narrow section 156, and the lower end section 158 of the plunger 150 are located below the installation surface 15.

The collection section 180, the fixing section 176, the restriction section 170, and the plunger 150 are detachable. The plunger 150is provided to be replaceable. When the plunger 150 is to be replaced, first, the fastening of the screws 182 is released and the collection section 180 is detached from the fixing section 176. Next, the fastening of the screw of the fixing section 176 is released, and the fixing section 176 is removed from the support section 160. Next, the first member 172 and the second member 174 of the restriction section 170 are separated from each other, and the restriction section 170 is removed from the support section 160. Then, the plunger 150 is removed from the support section 160. In this manner, the plunger 150 can be replaced.

### 1.2.3. Nozzle

As illustrated in FIG. 2, the nozzle 50 is provided on the -X axis direction side of the barrel 120. The nozzle 50 has a nozzle aperture 52 communicating with the communication hole 126. By the injection section 40 performing the measurement operation and the injection operation, the plasticized material measured in the cylinder 140 is supplied from the injection section 40 to the nozzle aperture 52 via the communication hole 126. The nozzle 50 injects the supplied plasticized material into the mold 70.

### 1.2.4. Mold opening and closing section

As illustrated in FIG. 1, the mold 70 is attached to the mold opening and closing section 60. The mold 70 has a movable mold 72 and a fixed mold 74 that face each other. A cavity corresponding to the shape of the molded article is formed between the movable mold 72 and the fixed mold 74. The material of the mold 70 is, for example, metal, ceramic, or resin.

The mold opening and closing section 60 includes a movable mold fixing section 62 that fixes the movable mold 72, a fixed mold fixing section 64 that fixes the fixed mold 74, and tie bars 66. The movable mold fixing section 62 is moved along the tie bars 66 by a mold drive section (not illustrated). By this, the mold opening and closing section 60 opens and closes the mold 70. The mold driving section is configured by, for example, a motor, a gear, and the like. The mold driving section is connected to the movable mold fixing section 62 via, for example, a ball screw section. The mold driving section may be accommodated in the accommodation section 13 of the foundation 12. The mold driving section is controlled by the control section 80.

### 1.3. Operations and effects

The injection molding system 100 includes the base 10, which has the installation surface 15, and the injection molding device 20, which is installed on the base 10 and which performs injection molding of a molded article using the mold 70. The injection molding device 20 includes the material supply section 30 that supplies the material for the molded article, the injection section 40 that injects the material supplied from the material supply section 30 into the mold 70, and the mold opening and closing section 60 to which the mold 70 is attached and that opens and closes the mold 70. The injection section 40 includes the cylinder 140 and the plunger 150 that moves in the cylinder 140. The material supply section 30 and the mold opening and closing section 60 are located above the installation surface 15. At least a portion of the injection section 40 is located below the installation surface 15. The injection section 40 injects the material into the mold 70 by the plunger 150 moving upward in the cylinder 140.

Therefore, in the injection molding system 100, it is possible to achieve miniaturization compared to a case where all of the injection section is provided above the installation surface. Specifically, the injection molding system 100 can be downsized in the direction parallel to the installation surface 15, and the area of the installation surface 15 can be reduced. As described above, since the injection molding system 100 is small, even when the plunger 150 is moved in the direction opposite to the direction of gravity in order to inject the material, the pressure loss is small. Furthermore, in the injection molding system 100, the center of gravity can be lowered, and stability during transportation and operation can be improved.

In the injection molding system 100, the material supply section 30 and the mold opening and closing section 60 are arranged in the horizontal direction. Therefore, in the injection molding system 100, the moving direction of the plunger 150 and the moving direction of the movable mold 72 of the mold 70 can be made to intersect with each other. This enables downsizing.

In the injection molding system 100, the injection section 40 has the collection section 180 that collects the material discharged from the cylinder 140, and the collection section 180 is located below the cylinder 140. Therefore, in the injection molding system 100, even when the material is discharged from the cylinder 140, the discharged material can be collected.

In the injection molding system 100, the hole section 181 as the first hole section through which the plunger 150 is inserted is formed in the collection section 180, and the plunger 150 has the tapered section 154 as the first portion located above the hole section 181 and the narrow section 156 as the second portion located below the tapered section 154. The diameter D2 of the tapered section 154 is larger than the diameter E2 of the hole section 181, and the diameter D3 of the narrow section 156 is smaller than the diameter E2 of the hole section 181. Therefore, in the injection molding system 100, even when the material is discharged from the cylinder 140, the discharged material can be suppressed from falling any further downward than the collection section 180.

In the injection molding system 100, the injection section 40 includes the support section 160, which is located below the plunger 150 and which supports the plunger 150, and the restriction section 170, which restricts the movement of the plunger 150 with respect to the support section 160. Also, the restriction section 170 and the plunger 150 are detachable. Therefore, in the injection molding system 100, when the plunger 150 needs to be replaced, the plunger 150 can be easily replaced.

In the injection molding system 100, the hole section 171 as the second hole section through which the plunger 150 is inserted is formed in the restriction section 170, and the plunger 150 has the intra-hole section 157 as the third portion located in the hole section 171 and the lower end section 158 as the fourth portion located below the intra-hole section 157. The diameter D4 of the lower end section 158 is larger than the diameter E1 of the hole section 171. Therefore, in the injection molding system 100, the movement of the plunger 150 from the support section 160 can be restricted with a simple configuration.

In the injection molding system 100, the injection molding device 20 includes the control section 80 that controls the injection section 40. The injection section 40 has a pressure detection section 164 that detects the pressure applied to the plunger 150, and the pressure detection section 164 is located below the plunger 150. When the pressure detection section 164 detects a pressure equal to or higher than a predetermined value, the control section 80 performs a process of causing the plunger 150 to suck the material. Therefore, in the injection molding system 100, the material can be injected into the mold 70 based on the pressure applied to the plunger 150.

### 2. Material Variations

Next, modifications of the material used in the injection molding system 100 of the present embodiment will be described. In the above description, an ABS resin is used as the material used in the injection molding system 100, but the material used in the injection molding system 100 may be a material other than an ABS resin or a material obtained by adding another component to the ABS resin.

Examples of materials that can be used in the injection molding system 100 include materials containing various materials such as a thermoplastic material, a metal material, and a ceramic material as a main material. Here, the "main material" means a material that is a center of the shape of the molded article molded by the injection molding system 100, and means a material that occupies a content ratio of 50% by mass or more in the molded article. The above-described materials include those obtained by melting the main material alone, and those obtained by melting some components contained together with the main material to form a paste.

As the material having thermoplasticity, for example, a thermoplastic resin can be used. Examples of the thermoplastic resin include general-purpose plastics, general-purpose engineering plastics, and super engineering plastics.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

The thermoplastic material may contain a pigment, metal, ceramic, or other additive such as wax, a flame retardant, an antioxidant, or a heat stabilizer. The material having thermoplasticity is converted into a state of being plasticized and melted by the rotation of the screw 110 and the heating of the heater 130 in the plasticization mechanism 34. The plasticized material thus generated is discharged from the nozzle 50 and deposited in the cavity, and then cured by a decrease in temperature.

In the plasticization mechanism 34, for example, a metal material may be used as the main material instead of the above-described material having thermoplasticity. In this case, it is desirable that a component that melts when the plasticized material is generated is mixed with a powder material obtained by pulverizing the metal material, and the mix is fed into the plasticization mechanism 34.

Examples of the metal material include a single metal such as magnesium (Mg), iron (Fe), cobalt (Co), chromium (Cr), aluminum (Al), titanium (Ti), copper (Cu), or nickel (Ni), an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticization mechanism 34, a ceramic material can be used as a main material instead of the metal material described above. Examples of the ceramic material include oxide ceramics such as silicon dioxide, titanium dioxide, aluminum oxide, and zirconium oxide, and non-oxide ceramics such as aluminum nitride.

The powder material of the metal material or the ceramic material may be a mixed material obtained by mixing a plurality of types of powders of a single metal, a powder of an alloy, and a powder of a ceramic material. The powder material of the metal material or the ceramic material may be coated with, for example, the above-described thermoplastic resin or another thermoplastic resin. In this case, the thermoplastic resin may be melted to exhibit fluidity in the plasticization mechanism 34.

A solvent may be added to the powder material of the metal material or the ceramic material. Examples of the solvent include water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ - picoline, and 2, 6-lutidine; tetraalkylammonium acetates (for example, tetrabutylammonium acetate); and ionic liquids such as butyl carbitol acetate.

In addition, for example, a binder may be added to the powder material of the metal material or the ceramic material. Examples of the binder include acrylic resin, epoxy resin, silicone resin, cellulose resin, other synthetic resins, PLA, PA, PPS, PEEK, and other thermoplastic resins.

The above-described embodiments and modifications are merely examples, and not limitations. For example, it is possible to appropriately combine the embodiments and the modifications.

The present disclosure includes substantially the same configuration as the configuration described in the embodiment, for example, it includes a configuration having the same function, method, and result, or a configuration having the same objective and effect. The present disclosure includes a configuration in which non-essential sections of the configuration described in the embodiment are replaced. The present disclosure includes a configuration that achieves the same effects as the configuration described in the embodiment or a configuration that can achieve the same objective as the configuration described in the embodiment. The present disclosure includes a configuration in which a known technique is added to the configuration described in the embodiment.

The following contents are derived from the above-described embodiments and modifications.

One aspect of an injection molding system includes
a base having an installation surface and
an injection molding device that is installed on the installation surface and that is configured to perform injection molding of a molded article using a mold, wherein
the injection molding device includes
   a material supply section that feeds a material of the molded article,
   an injection section that injects the material supplied from the material supply section into the mold, and
   a mold opening and closing section to which the mold is attached and that opens and closes the mold,
the injection section includes a cylinder and a plunger that moves in the cylinder,
the material supply section and the mold opening and closing section are located above the installation surface,
at least a portion of the injection section is located below the installation surface, and
the injection section injects the material into the mold by the plunger moving upward in the cylinder.

According to such an injection molding system, it is possible to achieve miniaturization.

The aspect of the injection molding system may be such that
the material supply section and the mold opening and closing section are arranged in a horizontal direction.

According to such an injection molding system, it is possible to achieve miniaturization.

The aspect of the injection molding system may be such that
the injection section includes a collection section configured to collect the material discharged from the cylinder and
the collection section is located below the cylinder.

According to such an injection molding system, even when the material is discharged from the cylinder, the discharged material can be collected.

The aspect of the injection molding system may be such that
the collection section is formed with a first hole section through which the plunger is inserted,
the plunger includes
a first portion located above the first hole section and
a second portion located below the first portion,
a diameter of the first portion is larger thana diameter of the first hole section, and
a diameter of the second portion is smaller than the diameter of the first hole section.

According to such an injection molding system, even when the material is discharged from the cylinder, the discharged material can be prevented from falling below the collection section.

The aspect of the injection molding system may be such that
the injection section includes
a support section that is located below the plunger and that supports the plunger and
a restriction section that restricts movement of the plunger with respect to the support section and
the restriction section and the plunger are detachable.

According to such an injection molding system, when the plunger needs to be replaced, the plunger can be easily replaced.

The aspect of the injection molding system may be such that
the restriction section is formed with a second hole section through which the plunger is inserted,
the plunger includes
   a third portion located in the second hole section and
   a fourth portion located below the third portion and
a diameter of the fourth portion is larger than a diameter of the second hole section.

According to such an injection molding system, the movement of the plunger from the support section can be restricted with a simple configuration.

The aspect of the injection molding system may be such that
the injection molding device includes a control section that controls the injection section,
the injection section includes a pressure detection section that detects a pressure applied to the plunger,
the pressure detection section is located below the plunger, and
when the pressure detection section detects a pressure equal to or higher than a predetermined value, the control section performs a process of causing the plunger to suck the material.

According to such an injection molding system, the material can be injected into the mold based on the pressure applied to the plunger.

An aspect of an injection molding device includes
an injection molding device for performing injection molding of a molded article using a mold, wherein
the injection molding device includes
   a material supply section that feeds a material of the molded article,
   an injection section that injects the material supplied from the material supply section into the mold, and
   a mold opening and closing section to which the mold is attached and that opens and closes the mold,
the injection section includes a cylinder and a plunger that moves in the cylinder, the material supply section and the mold opening and closing section are located above an installation surface of a base on which the injection molding device is installed,
at least a portion of the injection section is located below the installation surface, and
the injection section injects the material into the mold by the plunger moving upward in the cylinder.

According to such an injection molding device, it is possible to achieve miniaturization.

What is claimed is:

1. An injection molding system comprising:
a base having an installation surface; and
an injection molding device that is installed on the installation surface and that is configured to perform injection molding of a molded article using a mold, wherein
the injection molding device includes
a material supply section that feeds a material of the molded article,
an injection section that injects the material supplied from the material supply section into the mold, and
a mold opening and closing section to which the mold is attached and that opens and closes the mold,
the injection section includes a cylinder and a plunger that moves in the cylinder,
the material supply section and the mold opening and closing section are located above the installation surface,
at least a portion of the injection section is located below the installation surface, and
the injection section injects the material into the mold by the plunger moving upward in the cylinder.

2. The injection molding system according to claim 1, wherein
the material supply section and the mold opening and closing section are arranged in a horizontal direction.

3. The injection molding system according to claim 1, wherein
the injection section includes a collection section configured to collect the material discharged from the cylinder, and
the collection section is located below the cylinder.

4. The injection molding system according to claim 3, wherein
the collection section is formed with a first hole section through which the plunger is inserted,
the plunger includes
a first portion located above the first hole section, and
a second portion located below the first portion,
a diameter of the first portion is larger than a diameter of the first hole section, and
a diameter of the second portion is smaller than the diameter of the first hole section.

5. The injection molding system according to claim 1, wherein
the injection section includes
a support section that is located below the plunger and that supports the plunger, and
a restriction section that restricts a movement of the plunger with respect to the support section, and
the restriction section and the plunger are detachable.

6. The injection molding system according to claim 5, wherein
the restriction section is formed with a second hole section through which the plunger is inserted,
the plunger includes
a third portion located in the second hole section, and
a fourth portion located below the third portion, and
a diameter of the fourth portion is larger than a diameter of the second hole section.

7. The injection molding system according to claim 1, wherein
the injection molding device includes a control section that controls the injection section,
the injection section includes a pressure detection section that detects a pressure applied to the plunger,
the pressure detection section is located below the plunger, and
when the pressure detection section detects a pressure equal to or higher than a predetermined value, the control section performs a process of causing the plunger to suck the material.

8. An injection molding device configured to perform injection molding of a molded article using a mold, the injection molding device comprising:
a material supply section that feeds a material of the molded article;
an injection section that injects the material supplied from the material supply section into the mold; and
a mold opening and closing section to which the mold is attached and that opens and closes the mold, wherein
the injection section includes a cylinder and a plunger that moves in the cylinder,
the material supply section and the mold opening and closing section are located above an installation surface of a base on which the injection molding device is installed,
at least a portion of the injection section is located below the installation surface, and
the injection section injects the material into the mold by the plunger moving upward in the cylinder.
